(19) United States
(12) Patent Application Publication
(10) Pub. No.: US 2023/0309142 A1
(43) Pub. Date: Sep. 28, 2023

(54) METHODS AND APPARATUS FOR WIRELESS TRANSMIT/RECEIVE UNIT (WTRU) INITIATED CHANNEL OCCUPANCY TIME (COT)

(71) Applicant: INTERDIGITAL PATENT HOLDINGS, INC., Wilmington, DE (US)

(72) Inventors: Patrick Tooher, Montreal (CA); Aata El Hamss, Laval (CA); Faris Alfarhan, Montreal (CA); Dylan Watts, Montreal (CA)

(73) Assignee: INTERDIGITAL PATENT HOLDINGS, INC., Wilmington, DE (US)

(21) Appl. No.: 18/019,372

(22) PCT Filed: Aug. 8, 2021
(86) PCT No.: PCT/US2021/044751

§ 371 Date: Feb. 2, 2023

Related U.S. Application Data
(60) Provisional application No. 63/185,782, filed on May 7, 2021.
(60) Provisional application No. 63/091,626, filed on Oct. 14, 2020.
(60) Provisional application No. 63/061,544, filed on Aug. 5, 2020.

(51) Int. Cl. H04W 74/08

(52) U.S. Cl. CPC H04W 74/0808

(57) ABSTRACT

Methods and apparatus are described herein. A wireless transmit/receive unit (WTRU) includes a receiver, processor, and a transceiver. The receiver is configured to receive, from a base station (BS), configuration information that includes a WTRU-specific fixed frame period (FFP) and one or more configured grant (CG) resources. The processor is configured to determine whether to transmit data using a first CG resource of the one or more CG resources and whether to use either the B S-initiated channel occupancy time (COT) or a WTRU-initiated COT. The processor further performs a listen before talk (LBT) based on the COT the WTRU determined to use; and on a condition that the LBT was successful, a transmitter configured to transmit the data and uplink control information (UCI) in the first CG resource.

### CROSS-REFERENCE TO RELATED APPLICATIONS

This application claims the benefit of U.S. Provisional Application No. 63/061,544, filed Aug. 5, 2020, U.S. Provisional Application No. 63/091,626, filed Oct. 14, 2020, and U.S. Provisional Application No. 63/185,782, filed May 7, 2021, the contents of which are incorporated herein by reference.

### BACKGROUND

Channel access in an unlicensed frequency band may use Listen-Before-Talk (LBT) to attempt to gain access to a channel. In new radio (NR) Release 16 (Rel 16), channel access for shared spectrum was specified. In some cases, LBT may be mandated independently of whether the channel is previously occupied by a paired node. In other cases, immediate transmission after a short switching gap may be applied.

### SUMMARY

A wireless transmit/receive unit (WTRU) comprises a receiver, processor, and transmitter. The receiver may be configured to receive, from a base station (BS) configuration information that includes a WTRU-specific fixed frame period (FFP) and one or more configured grant (CG) resources. The processor may be configured to determine whether to transmit data using a first CG resource of the one or more CG resources, wherein the first CG resource occurs within the WTRU-specific FFP. The processor may be further configured to determine to use either a BS-initiated COT or a WTRU-initiated COT, wherein the determination is based on at least one of: (1) whether the BS-initiated COT overlapping the start of the first CG resource is detected; (2) whether the first CG resource overlaps a BS FFP idle period; (3) the priority used for listen before talk (LBT) by the BS for the BS-initiated COT; or (4) the priority of the data to be transmitted. The processor may be further configured to perform a LBT based on the COT the WTRU determined to use (i.e., BS-initiated COT or WTRU-initiated COT). On a condition that the LBT was successful, the transmitter may be configured to transmit the data and uplink control information (UCI) in the first CG resource.

The WTRU-initiated COT may also be used when at least part of the first CG resource overlaps an idle period of the BS FFP or the priority of the data to be transmitted is lower than the priority used by the BS for LBT of the BS-initiated COT. The LBT performed by the WTRU may be a full LBT or Type 1 LBT. The LBT performed by the WTRU may also be a short LBT or Type 2 LBT. The UCI may include a FFP-UCI that indicates the WTRU determined to use the BS-initiated COT or the WTRU-initiated COT.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is diagram of additional monitoring periods to detect channel vacancy;

FIG. 3 is a diagram of an example of when a channel availability signal may be transmitted; and

FIG. 4 is a diagram illustrating an exemplary method to enable a WTRU to initiate and/or share a COT.

### DETAILED DESCRIPTION

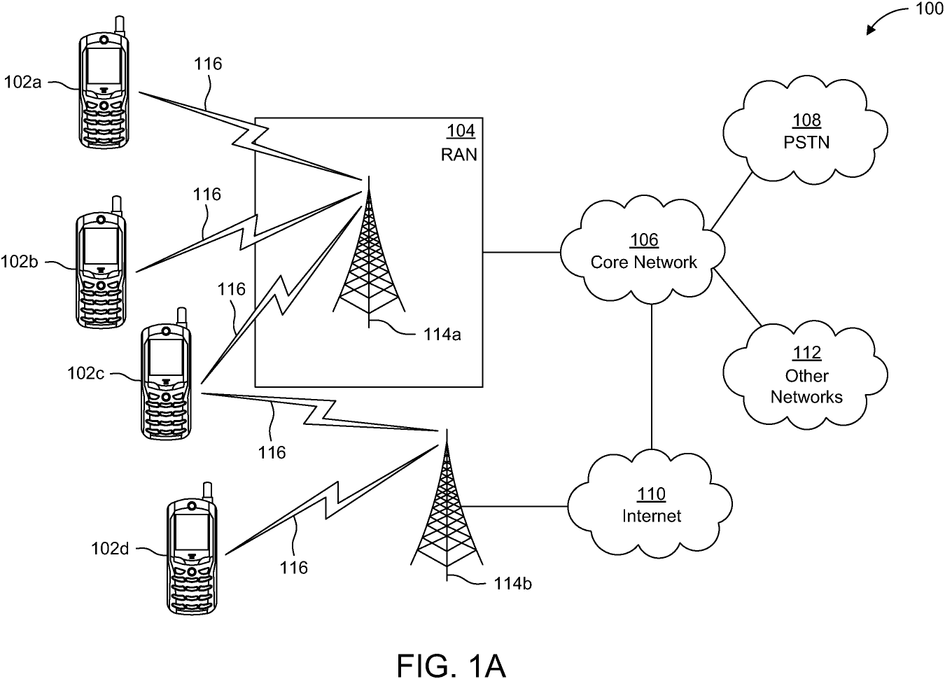

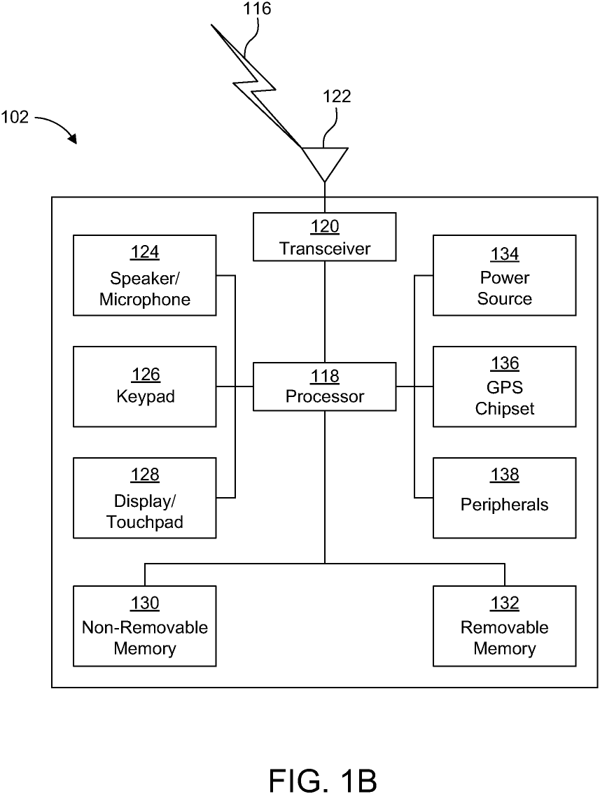

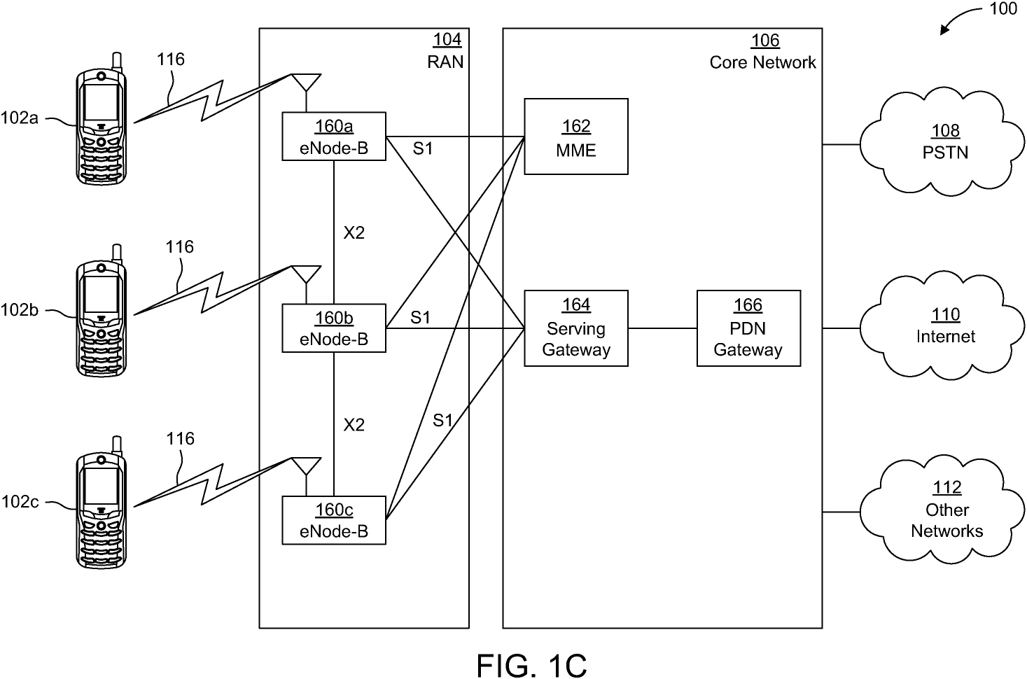

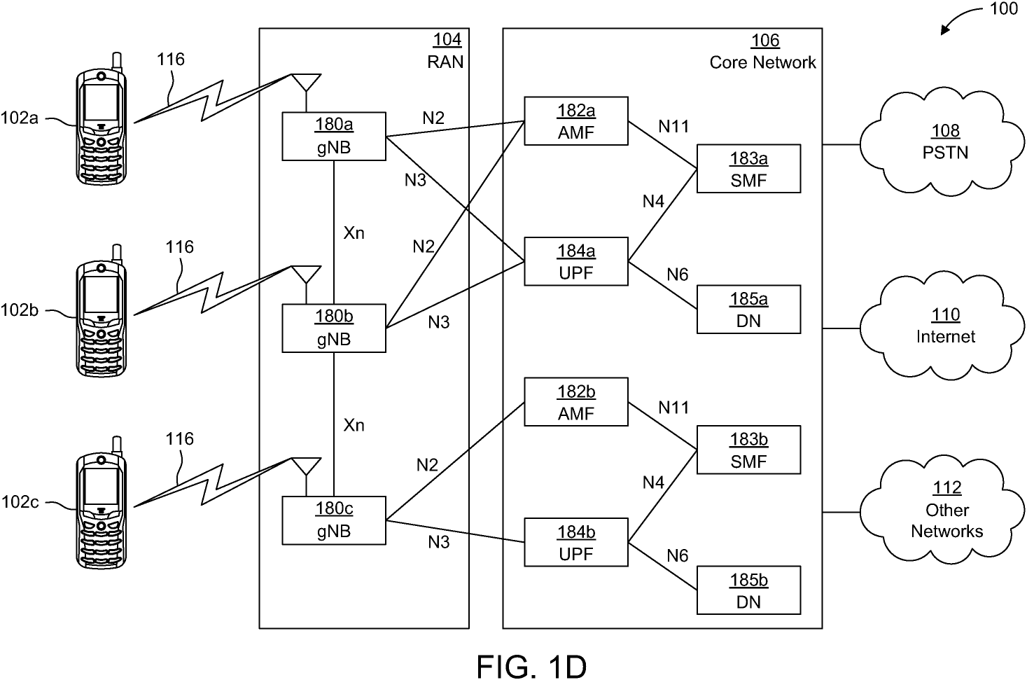

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two noncontiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For frame-based systems, such as systems that use Frame Based Equipment (FBE), LBT may be characterized by a Clear Channel Assessment (CCA) time (e.g., ~20 µs), a Channel Occupancy Time (COT) (e.g., minimum 1 ms, maximum 10 ms), an idle period (e.g., minimum 5% of channel occupancy time), a fixed frame period (FFP) (e.g., equal to the channel occupancy time + idle period), a short control signaling transmission time (e.g., maximum duty cycle of 5% within an observation period of 50 ms), and a CCA energy detection threshold.

For load-based systems, such as systems that use Load Based Equipment (LBE), LBT may be characterized by a number N corresponding to the number of clear idle slots in extended CCA instead of the fixed frame period. N may be selected randomly within a range.

For unlicensed spectrum in Long Term Evolution (LTE), there are generally two categories of CCA for both uplink and downlink. In the first category, a node may sense the channel for N slot durations, where N may be a random value selected from a range of allowed values (also referred to as a Contention Window). Contention window size and adjustments may depend on the channel access priority. LTE further supports LAA mode, in which a WTRU may operate in carrier aggregation (CA) with at least one carrier on licensed spectrum. In Release 15 (R15) LTE, Further enhanced Licensed Assisted Access (FeLAA) mode may support autonomous uplink transmissions (AUL), whereby the WTRU may autonomously transmit on a preconfigured active UL semi-persistent scheduling (SPS) resource, for which explicit hybrid automatic repeat request (HARQ) feedback may be provided via downlink feedback information (DFI).

In NR Rel-16, unlicensed operation (NR-U) is specified and may include stand-alone, license assisted, dual connectivity (DC), and CA operation. NR-based operation in unlicensed spectrum may support initial access, scheduling/HARQ, and mobility, along with coexistence methods with LTE-LAA and other incumbent radio access technologies (RATs). Deployment scenarios may include different standalone NR-based operations, different variants of DC operations (e.g., E-UTRAN NR DC (EN-DC) with at least one carrier operating according to the LTE RAT or NR DC with at least two sets of one or more carriers operating according to the NR RAT, and/or different variants of CA, which may include different combinations of zero or more carriers of each of LTE and NR RATs.

NR-U may support configured grant transmissions as well as code block group (CBG) based transmissions for the configured grant. In legacy LTE FeLAA systems, the WTRU may not generate a retransmission until an AUL timer has expired and HARQ feedback is not received, or until a negative acknowledgement (NACK) is received in DFI. Similarly, for NR-U systems, the WTRU may maintain a configured grant (CG) retransmission timer (CGRT) to control retransmissions on active CG(s), in addition to the legacy NR-R15 CG timer. The CGRT is started when the transport block (TB) is transmitted on the CG and stopped upon reception of HARQ feedback in DFI or reception of a dynamic grant (DG) for the same HARQ process. Upon expiry of the CGRT, the WTRU assumes a NACK for the TB previously transmitted on the CG, and the WTRU may be allowed to attempt another (re)-transmission on an active configured grant with the same HARQ process ID (PID).

In NR Rel 16, FBE operation was specified for the case where a gNB acquires a Fixed Frame Period (FFP) by performing LBT during the IDLE period of the FFP. In order for a WTRU to transmit in Rel 16 FBE operation, however, the gNB has to first acquire the channel and then share it with the WTRU. The WTRU may determine that the FFP has been acquired upon reception of a transmission from the gNB. For transmission on CG FBE, WTRUs therefore need to receive a transmission in the FFP prior to transmitting on a CG resource in an FFP. This may increase the latency of transmissions since a WTRU may not be able to transmit on a CG if the gNB has not acquired the FFP and, even if the gNB has acquired the FFP, the WTRU may not transmit at the beginning of an FFP since downlink (DL) transmissions may be required prior to an uplink (UL) transmission.

To make unlicensed spectrum useable by Ultra-Reliable and Low Latency Communications (URLLC) devices, it may be desirable for such latency to be minimized. Therefore, means may be desirable to enable an FBE WTRU to initiate a COT. Furthermore, it may be desirable to have means to enable WTRUs to have low latency access to CG resources for URLLC data that arrives in a buffer in a manner that does not lend itself well to fixed duration FFPs. Also, it may be desirable for a WTRU initiated FFP to be shareable with the gNB and possibly with other WTRUs to enable efficient use of the channel.

In embodiments, a WTRU may be configured with time instances when it may acquire a channel, which may be an LBT sub-band or set of LBT sub-bands. Such time instances may be referred to as IDLE periods. The WTRU may perform LBT or another channel access scheme during a configured IDLE period. If the WTRU determines that a channel is busy during such a period, the WTRU may not use the channel for the duration of the cycle (e.g., FFP). If the WTRU determines that the channel is not busy during the IDLE period, the WTRU may use resources located within the associated cycle/FFP.

In embodiments, a WTRU may be configured with channel acquisition parameters per configured channel acquisition resource. The channel acquisition parameters may include the parameters that the WTRU may use to acquire the channel or parameters that may enable the WTRU to indicate it has acquired the channel.

In embodiments, a WTRU may be configured with one or more FFPs, each of which may have their own timing, periodicity and offset. An FFP may be defined as a set of time, frequency and/or spatial resources or IDLE resources on which the WTRU may perform a channel access procedure (e.g., LBT) and an associated set of time, frequency and/or spatial resources on which a WTRU may transmit or expect to receive transmission if the channel was successfully acquired as determined by the channel access procedure. The parameters of the IDLE resources may be determined by at least one of a semi-static configuration; a dynamic indication; timing of the FFP; index of the FFP; priority of the data to be transmitted in the FFP; a set of resources to be used for transmission in the UL, DL or a combination of both, in the FFP; a pseudo-random sequence; and prior use of an FFP. For a semi-static configuration, a WTRU may be configured, for example, with parameters of the IDLE resources at the same time as the FFP configuration. For a dynamic indication, a WTRU may receive, for example, an indication prior to IDLE resources on channel access parameters associated with the IDLE resources. For timing of the FFP, a WTRU may determine, for example, parameters of the IDLE resource as a function of the timing or offset of an FFP. For a pseudo-random sequence, one or more parameters of an IDLE resource may, for example, be determined from a pseudo-random sequence with an initial seed. For example, a WTRU may generate a random sequence to determine a parameter of the IDLE resources. The randomization may ensure that different WTRUs have randomized likelihood of acquiring the channel and that fairness among WTRUs is observed. For example, the sequence may ensure that the timing within an IDLE period when a WTRU may perform LBT is randomized. In another example, the sequence may determine the CP value to use for the WTRU. The initial seed may be determined as a function of any of WTRU ID, priority of transmission, and FFP configuration. For prior use of an FFP, a parameter of an IDLE resource may be determined, for example, as a function of whether the node attempting to acquire the channel was successful in one or more previous (e.g., immediately preceding) FFP or FFPs.

In embodiments, the IDLE resource parameters that may be modified may include at least one type of channel access, timing of the channel access procedure within the set of IDLE resources, and cyclic prefix (e.g., the CP used for a transmission in the associated resources of the FFP). The cyclic prefix may, for example, enable randomizing the WTRUs that may transmit in an FFP.

In embodiments, a WTRU may indicate that it has successfully acquired a channel and is initiating a COT. For example, a WTRU may perform a channel access procedure in a set of IDLE resources to attempt to acquire a channel. If the WTRU successfully acquires the channel, it may initiate a COT that may be active for the remainder of the FFP. The WTRU may indicate that it has initiated a COT in an FFP (e.g., for efficient sharing of the COT among the gNB and possibly other WTRUs).

In embodiments, a WTRU may be configured with resources on which to transmit data within an FFP (e.g., if a COT has been initiated in the FFP). The WTRU may transmit data on those configured resources, and this may implicitly indicate to the gNB that the WTRU has initiated a COT for that FFP. However, in some cases, the WTRU may not be configured with resources immediately at the beginning of an FFP. Therefore, the WTRU may transmit an indication that the COT has been initiated prior to the configured grant resources. For example, this may enable efficient use of all the resources of an FFP.

In embodiments, a WTRU may transmit a signal or uplink control information (UCI) indicating a status of the COT (e.g., that a COT has been initiated, is ongoing or is terminated). Such a signal may be referred herein as an FFP-UCI. The FFP-UCI may indicate that a COT has been initiated and may also include parameters associated with the COT. The FFP-UCI may be transmitted in at least one of a Physical Uplink Shared Channel (PUSCH) transmission, a Physical Uplink Control Channel (PUCCH) transmission, a UL Reference Signal, and a Physical Random Access Channel (PRACH) transmission.

For a PUSCH transmission, for example, a WTRU may initiate a COT to transmit on a configured grant resource within the FFP. The WTRU may include the FFP-UCI in the CG transmission, which may, in embodiments, be multiplexed with or in addition to the CG-UCI. The FFP-UCI may be included in a PUSCH transmission if (e.g., only if) the PUSCH transmission occurs at the beginning of an FFP (or possibly within a pre-determined number of symbols at the beginning of an FFP).

For a PUCCH transmission, for example, a WTRU may be configured with PUCCH resources within an FFP (e.g., immediately at the beginning of an FFP) to transmit the FFP-UCI. The PUCCH resources may include time, frequency, spatial, orthogonal cover code, cyclic shift, interlace resources and/or PUCCH format. The WTRU may select one of multiple configured PUCCH resources. The selection may be determined as a function to implicitly provide FFP-UCI information. For example, the WTRU may select a PUCCH resource as a function of an information element of an FFP-UCI.

For a UL reference signal, for example, a WTRU may indicate initiation of a COT by the transmission of a UL reference signal (RS), such as a sounding reference signal (SRS), in a configured set of resources of an FFP. Parameters of the UL RS may also be adapted to provide specific contents of the FFP-UCI. For example, the sequence and/or resources used for an UL RS may be determined as a function of an information element of an FFP-UCI.

For PRACH transmission, a WTRU may transmit a PRACH transmission to indicate initiation of a COT. The PRACH transmission may be associated with PUSCH resources (e.g., 2-step RACH), and the contents of the FFP-UCI may be included in the associated PUSCH resources. The PRACH resource occasion used may be selected by the WTRU as a function of an information element of an FFP-UCI.

An FFP-UCI may be transmitted on resources spanning an entire LBT sub-band, for example, possibly using interlacing.

The selection of the resource and/or resource type on which to transmit the FFP-UCI may depend on a parameter of an associated transmission that triggered the WTRU to initiate a COT during the FFP. The parameter of an associated transmission may include at least one of priority of the transmission and/or resources on which the associated transmission may be performed. Regarding priority of the transmission, for example, a WTRU may use a first PUCCH resource for an associated transmission of a first priority and a second PUCCH resource for an associated transmission of a second priority. In another example, the WTRU may use a PUCCH resource for an associated transmission of a first priority and a PRACH resource for an associated transmission of a second priority. Regarding resources on which the associated transmission may be performed, for example, a WTRU may determine the FFP-UCI resource as a function of the slot or slots and/or RB or RBs within an FFP that it intends to use for an associated transmission. In another example, the WTRU may transmit the FFP-UCI on frequency and/or spatial resources on which the associated transmission may occur.

A WTRU may not transmit an FFP-UCI if it intends to use the first available resources of an FFP. In such a scenario, the WTRU may immediately occupy the COT upon acquiring the channel and initiating the COT. This may indicate to the gNB that the COT has been initiated. Furthermore, parameters of the COT may be semi-statically known by both the WTRU and the gNB and may, thus, not need to be indicated by the WTRU or may be determined by the lack of an FFP-UCI.

An FFP may be configured to operate on multiple LBT sub-bands. The WTRU may be configured to attempt to acquire all of the LBT sub-bands, all of the LBT sub-bands to be used for an associated transmission, or a subset thereof. The WTRU may initiate a COT if it has acquired all the configured LBT sub-bands, if it has acquired all the required LBT sub-bands for an associated transmission, or if it has acquired a minimum number of LBT sub-bands (e.g., one LBT sub-band).

The WTRU may transmit an FFP-UCI using any method described herein, on one or more LBT sub-bands, upon successfully acquiring one or more LBT sub-bands. The WTRU may be configured with at least one FFP-UCI resource per LBT sub-band. The WTRU may transmit FFP-UCI on at least one resource of each acquired LBT sub-band of the FFP. For example, an FFP-UCI may be transmitted or repeated in each acquired LBT sub-band. In another example, the FFP-UCI may span resources of multiple LBT sub-bands. In another example, the WTRU may determine a resource (e.g., in a single LBT sub-band or in a subset of acquired LBT sub-bands) where the WTRU may transmit the FFP-UCI. The determination may be based on the set of acquired LBT sub-bands (e.g., the set of LBT sub-bands that compose the COT). The determination of the resource (or LBT sub-band) on which the WTRU may transmit FFP-UCI may be similar to the case of a single LBT sub-band with multiple resources, as described herein. The FFP-UCI may indicate the set of acquired LBT sub-bands for the WTRU-initiated COT.

In embodiments, a WTRU may monitor and attempt to decode an FFP-UCI transmitted by another WTRU. A WTRU may be configured with FFP-UCI monitoring, which may include at least one of monitoring resource, monitoring reference signal (RS) and/or periodicity and offset. Regarding monitoring resource, for example, the WTRU may be configured with time/frequency/spatial resources on which to monitor for FFP-UCI. This configuration may reuse a CORESET configuration. The WTRU may have one or more monitoring resources per configured FFP. Regarding monitoring RS, for example, the WTRU may be configured with RS resources to enable decoding of the FFP-UCI. Regarding periodicity and offset, for example, the WTRU may have an FFP-UCI monitoring periodicity and offset. The periodicity and/or offset may be determined as a function of the timing of an FFP.

In embodiments, a WTRU may receive an FFP-UCI from a gNB. For example, a gNB may retransmit one or more FFP-UCIs it detects from one or more WTRUs. The WTRU may monitor for the initial FFP-UCI transmissions (e.g., from one or more other WTRUs), or it may monitor for the gNB’s retransmission. The retransmission may be a simple amplify-and-forward or detect-and-forward type of retransmission, where the gNB may not attempt to first decode the contents of the FFP-UCI. In some embodiments, the WTRU may expect a gNB transmission to include the contents of the FFP-UCI. For example, the WTRU may receive a COT structure indication or another DL signal from the gNB, and it may include the contents of at least one FFP-UCI transmitted by another WTRU.

A WTRU may be configured with multiple groups of FFP-UCI monitoring configurations. For example, one FFP-UCI monitoring configuration group may be such that the WTRU does not monitor for FFP-UCI at all. At any given moment, the WTRU may monitor for FFP-UCI using a single FFP-UCI monitoring configuration group. The WTRU may be triggered to switch between monitoring groups based on at least one of reception of a DL transmission, reception of an FFP-UCI, reception of a Reference Signal (RS), result of an LBT operation, transmission of an FFP-UCI, end of a COT, expiration of a timer, time and/or PDCCH monitoring. Regarding reception of a DL transmission, for example, if a WTRU receives a DL transmission in an FFP, it may switch to an FFP-UCI monitoring configuration group that leads to less (or no) FFP-UCI monitoring occasions in the FFP. In one example, it may be any DL transmission. In another example, it may be only DL transmissions indicating parameters of the COT (e.g., COT structure indication). Regarding reception of an FFP-UCI, for example, a WTRU may switch FFP-UCI monitoring configuration group if it has successfully detected and/or decoded an FFP-UCI. Regarding reception of an RS, the WTRU may switch FFP-UCI monitoring configuration group upon detecting an RS originating from the gNB or from another WTRU. Regarding result of an LBT operation, for example, the WTRU may determine an appropriate FFP-UCI monitoring configuration group as a function of the outcome of an LBT operation performed by the WTRU for that FFP. In an example, a WTRU may switch to an FFP-UCI monitoring configuration group with less or no FFP-UCI monitoring occasions if it has succeeded in acquiring the channel with a successful LBT operation. Regarding transmission of an FFP-UCI, for example, if a WTRU transmits an FFP-UCI, it may switch FFP-UCI monitoring configuration group, possibly for the remainder of the FFP. Regarding end of a COT, for example, a WTRU may determine that a COT has ended (e.g., at the end of an FFP) and may switch FFP-UCI monitoring configuration group. Regarding expiration of a timer, for example, a WTRU may trigger a timer upon switching FFP-UCI monitoring configuration group. Upon expiration of the timer, the WTRU may switch FFP-UCI monitoring configuration group (e.g., back to the previous group). Regarding time, for example, a WTRU may switch FFP-UCI monitoring configuration at the beginning or end of an IDLE (or sensing) period. Regarding PDCCH monitoring, for example, a WTRU may determine the FFP-UCI monitoring configuration as a function of the PDCCH monitoring or PDCCH monitoring group that is currently being used by the WTRU.

In embodiments, a WTRU may maintain FFP-UCI monitoring configuration groups per LBT sub-band. A WTRU may determine an active FFP-UCI monitoring configuration group in an LBT sub-band as a function of, for example, one of the above listed triggers occurring in the same LBT sub-band or in another (e.g., any other) LBT sub-band. For example, if the WTRU detects an FFP-UCI in a first LBT sub-band, it may switch FFP-UCI monitoring configuration group in that and some (or all) other LBT sub-bands.

In embodiments, a WTRU may be configured with one or more FFP-UCI monitoring configuration or configurations or one or more FFP-UCI monitoring configuration group or groups by semi-static signaling (e.g., radio resource configuration (RRC)). A WTRU may receive an FFP-UCI monitoring configuration in a synchronization signal block (SSB) or in a system information block (SIB). This may enable a WTRU to monitor for FFP-UCI prior to having RRC configuration.

A WTRU may receive, detect and/or decode an FFP-UCI transmission. The WTRU may decode the contents of the FFP-UCI. Based on the detection of an FFP-UCI or the contents of the FFP-UCI, the WTRU may be triggered to at least one of: use at least one of its configured UL resources, attempt to acquire a future FFP, adapt PDCCH monitoring, enable radio link monitoring (RLM)/ beam failure recovery (BFR) monitoring, reset UL LBT failure counters/timers, restart paused bandwidth part (BWP) timer, and/or perform channel state information (CSI) or L3 measurements, such as reference signal received power (RSRP), received signal strength indicator (RRSI), reference signal received quality (RSRQ), and signal-to-noise-ratio (SINR).

Regarding using at least one of its configured UL resources, for example, receiving the FFP-UCI and/or decoding the contents therein may enable the WTRU to perform at least one PRACH, SR, CG PUSCH, PUCCH or SRS transmission. In embodiments, some FFP-UCIs or contents therein may trigger the availability of conditional UL resources. For example, a WTRU may be configured with a set of CG PUSCH resources, and some CG PUSCH resources in an FFP may be activated upon receiving a certain trigger associated to an FFP-UCI.

Regarding attempting to acquire a future FFP, for example, a WTRU receiving an FFP-UCI may be triggered to perform LBT for a subsequent FFP. Such subsequent FFP may be considered restricted unless the WTRU receives appropriate trigger to attempt to acquire it. A WTRU may be configured with different types of FFPs. Some FFPs may be restricted. A WTRU may only initiate a COT on such restricted FFPs upon receiving an FFP-UCI in a prior FFP or upon having data of a specific priority to transmit.

Regarding adapting PDCCH monitoring, for example, the WTRU may change its PDCCH monitoring group as a function of receiving an FFP-UCI or of the contents therein). The adaptation of PDCCH monitoring may occur at (possibly multiple) specific time instances associated to the reception of the FFP-UCI. For example, the WTRU may change its PDCCH monitoring to a first group upon receiving the FFP-UCI, and the WTRU may change its PDCCH monitoring to a second group at a second time relative to either the timing of the FFP or the timing of the FFP-UCI. For example, the PDCCH adaptation may be a function of the FFP-UCI indicating to the WTRU that a COT is active. In another example, the PDCCH adaptation may be a function of the UL/DL configuration of the FFP (e.g., as indicated in the FFP-UCI).

Regarding enabling RLM/BFR monitoring, for example, a WTRU may pause RLM or BFR monitoring when there is no active COT. Upon determining that a COT has been initiated, for example by either a gNB or another WTRU, the WTRU may restart or enable RLM/BFR monitoring for at least the duration of the FFP.

Regarding resetting UL LBT failure counters/timers, for example, a WTRU may have ongoing UL LBT failure counters and or timers, for example associated with detection of a consistent UL LBT failure. Upon receiving an FFP-UCI or determining that a gNB or WTRU has initiated a COT, the WTRU may reset all LBT UL failure timers/counters if such COT enables the WTRU to transmit during the FFP.

Regarding restarting paused BWP timers, a WTRU may pause BWP switch timers (e.g., the BWP inactivity timer) when there is no active COT. Upon reception of an FFP-UCI or determining that a gNB or WTRU has initiated a COT, the WTRU may restart a paused BWP timer. The WTRU may pause a timer at the end of an FFP or COT.

Regarding CSI or L3 measurements, for example, upon reception of an FFP-UCI or determining that a COT has been initiated by a gNB or another WTRU, a WTRU may expect active RSs to be transmitted during the FFP, and the WTRU may perform configured CSI or L3 measurements on such RS.

In embodiments, a WTRU may be configured to send a UCI to indicate to the gNB the fixed frame period related parameters (FFP-UCI). Such UCI may be sent using one of the uplink channels as mentioned in previous sections or, alternatively, using a preamble signal after acquiring the channel, such as after a successful LBT procedure. The transmitted channel/signal/preamble may be detected by other WTRUs and used to determine some of the channel related information. A WTRU may be configured to send one or more of the following as part of FFP-UCI: an indication of the desired UL/DL pattern for the beginning of a COT duration and before the WTRU’s uplink transmission, an indication of the desired UL/DL pattern for the remaining available COT duration, an indication of the intended uplink transmission type or resource, one or more acquired LBT sub-bands, energy detection threshold used by a WTRU to acquire the channel, spatial parameters used to perform clear channel assessment, and vacating an FFP.

Regarding indication of the desired UL/DL pattern, for example, a WTRU may be configured with an uplink CG resource that is occurring later in the frame period. A WTRU may acquire the channel at the beginning of the frame period and send an uplink transmission to indicate to the gNB the desired UL/DL pattern to be used prior to the uplink transmission or to be used after the uplink transmission. The available UL/DL pattern for a WTRU to select from, as well as the selection, are described in more detail below.

Regarding indication of the intended uplink transmission type or resource, for example, a WTRU may be configured with multiple configured grant (CG) resources within a fixed frame period. The different CGs may be configured at different time instances. A WTRU may access the channel only at the beginning of a frame period and send the FFP-UCI. After acquiring the channel, a WTRU may send FFP-UCI to indicate the intended CG resources to be used. Such information may be used by the gNB to use the unused resources for other transmissions. In case the FFP-UCI can be received by other WTRUs, this information may be used by WTRUs to use or skip a configured grant resource.

Regarding acquired LBT sub-bands, for example, a WTRU may operate on wideband operation, where the channel bandwidth is divided into multiple LBT sub-bands. In some embodiments, a WTRU may send a bitmap with a size equal to the number of sub-bands within the bandwidth with a bit value equal to 1 meaning the LBT sub-band is acquired. In some embodiments, a WTRU may indicate the LBT sub-band indices that are acquired.

Regarding energy detection threshold used by a WTRU to acquire the channel, for example, a WTRU may be configured with multiple thresholds to use for energy detection when performing clear channel assessment. The energy detection threshold indication may be used by other WTRUs to determine the maximum transmit power allowed for the shared channel occupancy.

Regarding spatial parameters used to perform clear channel assessment, for example, a WTRU may be configured to perform directional LBT on one or more pre-configured beams. A WTRU may indicate using the one or more FFP-UCI beams where energy detection was performed.

Regarding vacating an FFP, for example, an FFP-UCI may indicate that a WTRU has performed all the desired transmissions in an FFP or that it need not use any other UL resources for transmission within the FFP.

In embodiments, a WTRU may be pre-configured/configured with a set of UL/DL patterns that may be selected for an FFP and may be indicated as part of FFP-UCI. In some embodiments, the set of patterns available for a WTRU may be fixed in the specification or configured using broadcasted SIBs. In some embodiments, a WTRU may be configured using RRC signaling with the set of available patterns. The configuration may be a cell specific configuration or bandwidth part specific configuration. The configuration may be a WTRU-specific configuration or common configuration to all WTRUs.

In some embodiments, a WTRU may be configured to select a UL/DL pattern from the preconfigured/configured patterns based on one or a combination of transmission parameters of the intended UL transmission or transmissions, number of selected CG configurations for transmission, acquired LBT sub-band or sub-bands, buffer status of the WTRU, whether the UL/DL pattern is preceding the intended uplink transmission or after, the FFP and/or the priority of the transmission. Regarding transmission parameters of the intended uplink transmission or transmissions, for example, this may be based on the time domain resource duration of the selected configured grant or based on the gap between the selected CG transmissions if a WTRU selected more than one CG transmission. Regarding number of selected CG configurations for transmission, a WTRU may select more than one CG transmission and may select a UL/DL pattern based on the number of intended transmissions. Regarding acquired LBT sub-band or sub-bands, for example, if a WTRU acquired only one LBT sub-band, the WTRU may select a UL/DL pattern with more UL slots/symbols. Regarding buffer status of WTRU, for example, a WTRU may have data on its buffer and expect a dynamic grant within the shared COT. A WTRU may then request a UL/DL pattern with more uplink slots/symbols in that case. Regarding whether a UL/DL pattern is preceding the intended uplink transmission or transmissions or after, for example, some of the pre-configured or configured patterns may be used only toward the end of a COT and other UL/DL patterns may be used only during the beginning of a COT. Regarding the FFP, for example, each FFP may be assigned an index. The WTRU may select from a set of available UL/DL patterns based on the timing of the FFP or the index of the FFP. Regarding the priority of a transmission, for example, a WTRU may select from a first set of possible UL/DL patterns for transmission of a first priority and select from a second set of possible UL/DL patterns for transmission of a second priority.

A WTRU operating in an FBE environment may not perform LBT at the given period if it does not have data available to transmit. However, throughout the duration of the FFP after the LBT period, time sensitive data may arrive for the WTRU to transmit. Depending on, for example, the duration of the FFP and/or the delay budget associated with the data, the WTRU may not be able to wait until the end of the FFP to attempt channel access. The WTRU may be able to access the channel during the FFP even though it has not performed an LBT procedure if, for example, the WTRU that has initiated the COT on the channel has finished data transmission or if the initiating WTRU’s data may be transmitted at a later time in the frame thus freeing up channel resources.

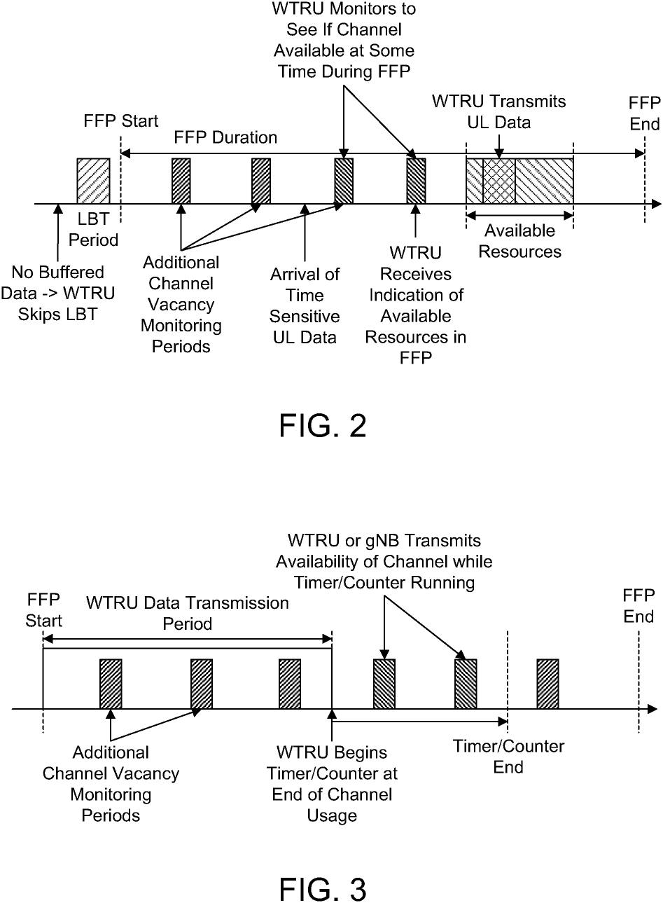

In some embodiments, there may be additional monitoring occasions throughout the FFP where a WTRU may monitor for a signal indicating the availability in the channel. An example of this is shown in FIG. 2. Reception of this signal may indicate, for example, that the remaining UL resources in the FFP are available for transmission. Alternatively, the signal may contain additional information regarding a specific set of resources that may be available within the FFP (e.g., a set of slots or other combinations of time-frequency resource indications).

As shown in FIG. 3, a WTRU may monitor for a channel availability signal at one or more occasions within the FFP. In some embodiments, the one or more occasions may be defined via a pre-defined pattern, which may be associated with characteristics of the FFP (e.g., the duration of the FFP or the frame that the FFP starts). This pattern may be configured semi-statically and signaled to the WTRU via, for example, RRC signaling, or may be transmitted at the beginning of the FFP uniquely or in conjunction with the UL/DL FFP pattern. In embodiments, the WTRU may only monitor the occasions if it has data to transmit.

In other embodiments, the monitoring occasions may be configured via an offset and periodicity. The offset may indicate the amount of time or number of fixed set of resources, such as slots or RBs, from the beginning of the FFP to the beginning of the first monitoring period. If more than one monitoring occasion is configured, the WTRU may also be provided with a periodicity to identify the remaining number of monitoring occasions throughout the FFP. Such configurations may be provided dynamically at the beginning of the FFP by the network, be associated with characteristics of the FFP such as duration or starting frame number, or configured semi-statically by, for example, RRC signaling.

The monitoring duration of the additional period or periods may be fixed (e.g., an identified resource or set of resources such as an RB) or may be subject to a configurable timer or counter to allow for dynamic modification of the monitoring duration.

In some embodiments, the signal indicating channel availability for the FFP may be transmitted by the WTRU, which initially was scheduled to transmit on those resources. The WTRU may address other WTRUs within the cell via transmission of a common preamble, which other WTRUs may detect. In other embodiments, the WTRU may transmit an indication to the network that it may not require a subset of resources, and the network may relay this information to all WTRUs within the cell at the designated monitoring periods. The network may additionally restrict this transmission to a subset of WTRUs that have resources configured within the available resources.

The WTRU and/or gNB may transmit the signal indicating available channel resources. For example, the WTRU and/or gNB may transmit the signal indicating available channel resources: (1) at the first available occasion after the completion of usage from the WTRU which has reserved the channel; (2) in one or more periods before the completion of usage to provide an advanced notification to UEs of upcoming resources; or (3) on all occasions within a timer/counter. The timer and/or counter may be started upon completion of data transmission or channel usage by the WTRU, which has the resources reserved. As shown in FIG. 3, the WTRU or gNB may transmit on all occasions which fall within the counter or timer duration. This counter/timer may be configurable by the network.

In some embodiments, upon detection of the channel availability signal, a WTRU may transmit applicable buffered data (e.g., subject to, for example, grant LCP restrictions or if the WTRU has configured resources) on resources that were indicated to be available. In other embodiments, upon detection of available resources, the WTRU may be subjected to one or more of restrictions to transmit on available resources. Examples of such restrictions may include, for example, only buffered data with a certain priority level or associated with a subset of LCHs, only if latency/delay budget is such that it may expire before the end of the FFP, only data belonging to a specific traffic type, such as URLLC data, and/or if the WTRU has configured resources that fall within the period of channel availability.

In some embodiments, should the WTRU be restricted from transmitting the buffered data during the period of channel availability, it may alternatively send another UL transmission, such as an SR or BSR, to the network for future scheduling/allocation of resources.

A WTRU may be configured with multiple FFP configurations, whereby each FFP configuration may at least include parameters described below. The WTRU may be configured with some FFP configurations such that an FFP may be used by the gNB only, the WTRU and the gNB, or the WTRU only.

The WTRU may be configured by common or dedicated semi-static signaling (e.g., RRC) or may receive some configurations by broadcast signaling for any of the following FFP and IDLE resource configuration parameters and FFP-UCI related configuration parameters.

FFP and IDLE resource configuration parameters may include, for example, time, frequency, and/or spatial resources associated with CCA on IDLE resources and FFP duration or period in ms, symbols, or slots. An IDLE period may be used for multiple FFPs of different durations, but with the same start offset. FFP and IDLE resource configuration parameters may additionally or alternatively include, for example, FFP start time or offset, which may be specific to the WTRU (e.g., received by RRC dedicated signaling). An IDLE period may be used for multiple FFPs of different starting offsets but use the same duration. FFP and IDLE resource configuration parameters may additionally or alternatively include, for example, LBT and CCA parameters associated with the FFP/FFP configuration, including the energy detection threshold (ED), CAPC, and/or channel access type or types and/or indication of applicable FFP or FFPs to the WTRU. For example, if multiple FFP configurations are provided by broadcast signaling, the WTRU may receive a dedicated configuration specifying which FFP or FFPs are applicable for the WTRU. FFP and IDLE resource configuration parameters may additionally or alternatively include, for example, applicable FFP occasions, which may be time instances applicable for acquiring the channel/IDLE periods. The WTRU may be configured with a pattern to determine which IDLE periods are applicable. In another example, the WTRU may have restricted IDLE periods. Such periods may only be used for channel acquisition if the WTRU is triggered to use them. The trigger may be determined by at least one of priority of the transmission, indication by the gNB, indication by another WTRU, prior LBT outcome on a prior FFP (possibly from the same or a different FFP configuration), and/or channel measurements. FFP and IDLE resource configuration parameters may additionally or alternatively include, for example, indication of applicable FFP or FFPs to the gNB. This may include, for example, the subset of FFPs applicable for channel acquisition only by the gNB. FFP and IDLE resource configuration parameters may additionally or alternatively include, for example, an indication of applicable FFP or FFPs applicable for channel acquisition by either the WTRU or the gNB. The WTRU may be configured with FFPs on which COTs may be or may only be initiated by the WTRU. The WTRU may be configured with FFPs on which COTs may be or may only be initiated by the gNB.

FFP and IDLE resource configuration parameters may additionally or alternatively include, for example: a list of applicable priorities associated with the FFP and/or an initial seed and/or sequence used to determine the resource allocation of the IDLE resource for an FFP. Such seed may be configured per FFP configuration or per WTRU (e.g., using dedicated RRC signaling). FFP and IDLE resource configuration parameters may additionally or alternatively include, for example, applicable channel access types per FFP. The WTRU may acquire the channel/LBT on this FFP configuration if the channel access type matches the configured applicable type or types for this FFP. FFP and IDLE resource configuration parameters may additionally or alternatively include, for example, applicable uplink signals and/or channels applicable per FFP. The WTRU may acquire the channel/LBT on this FFP configuration if the uplink signal and/or channel intended for transmission matches the configured applicable type or types for this FFP. FFP and IDLE resource configuration parameters may additionally or alternatively include, for example, applicable LCH or LCHs and/or LCG or LCGs to acquire the channel per FFP. The WTRU may acquire the channel/LBT on this FFP configuration if all LCHs or LCGs, at least one LCH or LCG, or the highest priority LCH or LCG included in the PDU intended for transmission matches the configured applicable type or types for this FFP. FFP and IDLE resource configuration parameters may additionally or alternatively include, for example, applicable sub-band and/or BWPs. There may be FFPs in different LBT sub-bands. A WTRU may attempt to acquire multiple FFPs over multiple LBT sub-bands, possibly simultaneously and/or possibly partially overlapping in resource allocation. FFP and IDLE resource configuration parameters may additionally or alternatively include, for example, the UL/DL pattern associated with the FFP. The UL/DL pattern may be a function of the timing (or index) of the FFP. For example, the WTRU may determine that a subset of IDLE periods associated with the FFP are applicable as a function of the associated UL/DL traffic pattern (e.g., whether there is an overlapping DL or UL traffic arrival occasion). FFP and IDLE resource configuration parameters may additionally or alternatively include, for example, applicable WTRU behavior. For example, the WTRU may be configured with a set of FFPs within which it may (or may not) perform channel measurements, perform RLM/BFR, transmit PRACH preamble, and/or keep timers running (e.g., BWP inactivity timer, RAR timer, and/or CG timer).

FFP-UCI related configuration parameters may include, for example: number of symbols (PUCCH, SRS, and/or PUSCH) associated with the FFP-UCI transmission, format and sequence of any associated reference signal or signals, PRACH resource and/or preamble format associated with the FFP-UCI, and/or resources associated with monitoring FFP-UCI from other WTRUs or gNBs. Such resources may include, for example, for each resource, applicable monitoring occasions and/or a monitoring periodicity and offset. FFP-UCI related configuration parameters may additionally or alternatively include, for example, a list of FFP-UCI monitoring configuration groups, which may include, for example, for each group, periodicity and offset of monitoring. FFP-UCI related configuration parameters may additionally or alternatively include applicable sub-bands and/or BWPs, applicable priorities (LCHs and/or LCGs), and/or applicable signals and channels as trigger to transition to a different group. A WTRU may transition to monitor a different FFP-UCI group for transmission of applicable signals and/or channels from this list.

A WTRU may be configured with multiple FFPs on which it may initiate a COT. Such multiple FFPs may overlap in time. For example, a WTRU may have multiple FFPs with the same start time but with different durations. The WTRU may select an FFP on which to initiate a COT for a UL transmission. The selection may depend on at least one of: the timing of the resource on which the WTRU may perform a UL transmission and for which the WTRU may initiate a COT, the amount of data to transmit, priority of transmission, type of transmission, content of transmission, logical channel, previous FFP selection, whether there is an ongoing COT initiated by another node (e.g., gNB or other WTRU), and/or time since last COT. Regarding the timing of the resource on which the WTRU may perform a UL transmission and for which the WTRU may initiate a COT, for example, a WTRU may only select an FFP if the difference between the FFP start time and the timing of the resource on which the WTRU may transmit, is less than x, where x may be 0 ms (e.g., the WTRU may only select an FFP on which to initiate a COT if the FFP start time matches the time of the UL resource). Regarding the amount of data to transmit, for example, the WTRU may select an FFP duration based on the amount of data it needs to transmit. Regarding priority of transmission, for example, the WTRU may select an FFP for a URLLC type transmission and another FFP for an eMBB type transmission. Regarding type of transmission, for example, the WTRU may determine the appropriate FFP based on whether the transmission is PRACH, 2-step PRACH, PUSCH, PUCCH, SRS. Regarding the content of the transmission, for example, the WTRU may determine the appropriate FFP based on whether the transmission includes data or control (and possibly the type of control). Regarding logical channel, for example, the WTRU may select an FFP as a function of the LCH(s) that are multiplexed in the transmission.

When the WTRU may select from a set of possible FFPs, the WTRU may indicate to the gNB the FFP on which the WTRU has initiated a COT. For example, if the WTRU has multiple FFP configurations with the same start time but with different durations, the WTRU may indicate the FFP used for the COT given that this may indicate to other nodes the timing of the upcoming idle period/resource. Such an indication may be provided in an FFP-UCI type transmission. In such a case, the FFP-UCI may be multiplexed with a UL transmission occurring at the beginning of the COT.

A WTRU may be configured with multiple channel access configurations. A channel access configuration may include at least one of a channel access type, a channel sensing method and parameters of a channel configuration. A channel access type may indicate, for example, at least one of LBE, FBE, dynamic channel access and/or semi-static channel access. A channel sensing method may include, for example, an LBT or an LBT type or category. An LBT type may include at least one of omni-directional LBT, quasi-omni-directional LBT, directional LBT, and/or receiver assisted LBT. An LBT type may also include no LBT. In such a case, a WTRU may access a channel without using a channel sensing method prior to transmitting. An LBT category may include, for example, at least one of full LBT (e.g., cat-4 or Type 1) and/or one-shot LBT (e.g., cat-2). Parameters of channel configuration may include, for example, parameters associated to an LBT (e.g., CAPC, CWS, sensing beam, EDT, LBT bandwidth) and/or parameters associated with a channel access type (e.g., FFP configuration).

For example, a WTRU may be configured with two channel access configurations. A first channel access configuration may include a first LBT type to be used. A second channel access configuration may include a second LBT type (e.g., no LBT) to be used. This may enable a WTRU to switch between using and not using LBT for channel access. Both channel access configurations may have the same FFP configuration.

In embodiments, the WTRU may be configured with a fallback or default channel access configuration. For example, a fallback or default channel access configuration may enable the WTRU to perform a first LBT type of a first LBT category in a semi-static manner using a first FFP configuration. The WTRU may use the fallback channel access configuration unless indicated otherwise. The WTRU may determine the appropriate channel access configuration using methods described herein for the selection of an FFP configuration. In another method, a WTRU may receive an indication informing the WTRU to use a specific channel access configuration. The WTRU may receive such an indication by at least one of control signaling, DL channel or symbol, RRC configuration and/or MAC CE. Regarding control signaling, for example, a WTRU may receive a DCI indicating a channel access configuration to use. The DCI may be a DCI scheduling a transmission, and the channel access configuration may be used at least for the scheduled transmission. The indication may be explicitly provided in the DCI. In another method, the indication of the channel access configuration to use for a transmission/reception may be tied to a parameter provided in the DCI. For example, the transmit power control value or the resource allocation in the DCI may inform the WTRU as to which channel sensing configuration to use. Regarding DL channel or symbol, for example, upon receiving a transmission of a DL channel or signal, a WTRU may use a specific or associated channel access configuration for at least one subsequent transmission/reception. Examples of DL channels or symbols may include, for example, SSB, RS (e.g., CSI-RS, DM-RS, PT-RS), PDCCH, and/or PDSCH. Regarding RRC configuration, for example, a WTRU may be RRC configured to one or more channel access configuration for one or more subsequent transmissions or receptions.

A WTRU may be configured with triggers to determine when to use a fallback channel access configuration. The determination may be performed using a method described herein for FFP configuration selection. Furthermore, triggers to determine when to use a fallback channel access configuration may include at least one of measurements and/or previous channel access performance. Regarding measurements, for example, a WTRU may be configured with a set of measurement resources and a set of measurements and thresholds. If at least one measurement goes above or below a threshold value, the WTRU may use a fallback channel access configuration for at least one subsequent transmission. Examples of resources on which a WTRU may obtain a measurement include RS (e.g., ZP CSI-RS, NZP CSI-RS, DM-RS, PT-RS or CSI-IM). The resources may be located in a single LBT BW or in multiple LBT BWs (where a set of LBT BWs may span a BWP). The resources may be included in an active BWP or an inactive BWP. Examples of measurement types that may be used include L1 measurements (e.g., SINR, CQI, RI, PMI), L3 measurements (e.g., SINR, RSRP, RSRQ, RSSI), and/or channel sensing measurements (e.g., energy measurement performed in a channel sensing slot). Regarding previous channel access performance, for example, if the WTRU succeeds or fails at x previous (e.g., consecutive) channel access attempts (e.g., in a time period y), the WTRU may change to a fallback channel access configuration.

The WTRU may determine the triggers and the associated parameters as a function of the configured or fallback channel access configuration. For example, when operating using a first (e.g., non-fallback) channel access configuration, the WTRU may use a first set of triggers to determine when to use a second (e.g., fallback) channel access. When operating using a second (e.g., non-fallback) channel access configuration, the WTRU may use a second set of triggers to determine when to use a third (e.g., fallback) channel access configuration.

A WTRU may indicate to the gNB the channel access configuration used for a transmission. The WTRU may report this for each transmission or reception. In another method, the WTRU may report the channel access configuration in a periodic manner. In another method, the WTRU may report the channel access configuration used whenever the WTRU is triggered to change the channel access configuration.

A WTRU may indicate to the gNB a desired change of channel access configuration. For example, a WTRU may be configured with measurement resources and measurement reports. The WTRU may be triggered to report a measurement (e.g., SINR, CQI, RI, PMI, RSRP, RSRQ, RSSI, ED value, and/or LBT outcome). The measurement report trigger may be determined when comparing a measurement to a possibly configurable threshold. In an example, a WTRU may report a desire to change channel access configuration as a function of a set of failed UL LBT. This may enable the WTRU to attempt a subsequent UL transmission using a different channel access configuration, prior to suffering UL LBT failure.

A WTRU may report channel access performance for a set of channel access configurations. For example, a WTRU may maintain a set of UL LBT performance, one for each configured channel access configurations.

In some cases, a WTRU may need to perform a UL transmission in a resource (e.g., CG transmission). The WTRU may either initiate a COT using an appropriate FFP configuration or may reuse an active COT if one encompasses the resources of the desired UL transmission. The WTRU may be configured to always reuse an existing COT if one exists for the resource. In such a case, the WTRU may not need to perform LBT. In another method, the WTRU may be configured to always reinitiate a new COT, using an appropriate FFP configuration, for example when it needs to perform a UL transmission on a configured resource (e.g., a grant-free UL transmission). In yet another method, the WTRU may determine on a case by case basis whether to reuse an existing COT or to initiate a new COT on a new FFP configuration. The WTRU may make such a determination as a function of at least one of the identity of the node that initiated an ongoing COT, the priority level of the COT, configuration, the transmission type/channel/signal, and/or the number of consecutive COTs within which new COTs were initiated.

Regarding the identity of the node that initiated an ongoing COT, for example, if the ongoing COT was initiated by the WTRU, the WTRU may continue using the COT and may not initiate a new COT on a new FFP. Regarding the priority level of the COT, for example, if the COT was acquired for high priority transmission and the WTRU needs to transmit a low priority transmission, the WTRU may initiate a new COT on a new FFP. Regarding configuration, a WTRU may be configured via higher layer signaling whether it may initiate a new COT if there is an ongoing COT. In another method, a WTRU may be dynamically indicated whether it may initiate a new COT for an UL transmission if there is an ongoing COT. For example, the WTRU may receive scheduling for a UL transmission and the scheduling may include information whether the WTRU may or may not initiate a new COT if there is an ongoing COT. In another example, the WTRU may receive an indication during a first ongoing COT (e.g., gNB-initiated COT) whether a second COT may be initiated during the resources of the first ongoing COT. Regarding the transmission type/channel/signal, for example, a WTRU may initiate a new COT if the transmission is for one set of channels (e.g., PRACH) but may not initiate a new COT if the transmission is for another set of channels (e.g., PUSCH). Regarding the number of consecutive COTs within which new COTs were initiated, for example, a WTRU may initiate a first COT in a first FFP. While the first COT is active, the gNB may initiate a second COT in a second (e.g., overlapping) FFP. The WTRU may not be able to initiate a third COT in a third FFP if the third FFP overlaps any of the first FFP or the second FFP. This may ensure that there may not be re-initiation of FFPs without ever observing any IDLE period. The rule may depend on whether the WTRU itself has initiated any of the COTs in the set of overlapping COTs. For example, if a first WTRU initiates a first COT in a first FFP, and a gNB initiates a second COT in a second FFP that is overlapping the first FFP, the first WTRU may not be allowed to initiate a third COT in a third FFP that is overlapping either the first or second FFP. However, a second WTRU may be allowed to initiate a third COT in a third FFP that is overlapping the first or second FFP. The examples provided here are for a maximum of two overlapping COTs being initiated by different nodes. However, this rule may be defined for a possibly configurable number of consecutive overlapping COTs.

For cases where multiple COTs are initiated in overlapping FFPs, the IDLE period to be observed by the WTRU (e.g., the resources on which there may be no transmissions) may be determined based on the configuration of the FFP used for the last initiated COT. In another method, a WTRU may observe any IDLE period that is determined from the configuration of a first FFP on which a WTRU initiated a COT in a set of overlapping FFPs used for COTs. For example, a WTRU may initiate a first COT in a first FFP, and a gNB may initiate a second COT in a second FFP that overlaps the first FFP. The WTRU may observe the IDLE period associated to the first FFP (e.g., since it is associated to the last COT initiated by the WTRU), or the IDLE period associated to the second FFP (e.g., since it is associated to the last COT initiated in a set of overlapping FFPs used for COTs). If the WTRU initiates a third COT in a third FFP that is overlapping with at least the second FFP, the WTRU may observe an IDLE period associated to the third FFP (e.g., since it is the last COT initiated by the WTRU). In yet another method, the WTRU may determine the IDLE period to observe based on a rule that dictates the WTRU to observe an IDLE period associated to the latest up to the n^{th} overlapping FFP configuration. In the example above with three overlapping FFPs, the WTRU may be configured to observe the IDLE period associated up to the latest FFP up to the second FFP. In such a case, even though the WTRU initiates a third COT in a third FFP, it may observe the IDLE period associated with the second FFP.

A WTRU may be configured with conditional FFP configurations. A conditional FFP configuration is one on which a WTRU may initiate a COT if or only if a condition has been met. The condition to enable a WTRU to initiate a COT on an FFP may include at least one of: indication from the gNB, the timing of a previously acquired COT, priority of a transmission, and/or outcome of a previous attempt to initiate a COT. Regarding indication from the gNB, the WTRU may only initiate a COT on an FFP if it receives an indication from the gNB enabling the WTRU to initiate a COT on the FFP. For example, the WTRU may monitor DL transmissions prior to initiating a COT, and, upon receiving the appropriate trigger, the WTRU may initiate a COT on an FFP. Such a DL transmission may be a group common or WTRU-specific DCI or an RS. In another example, a WTRU may determine whether the condition to initiate a COT on one or more upcoming FFPs is satisfied as per reception or contents of a broadcasted signal from the gNB (e.g., SSB or PBCH). Regarding the timing of a previously acquired COT, for example, a WTRU may be allowed to initiate a COT on an FFP if the time elapsed since a last previously used COT (e.g., WTRU-initiated and/or gNB-initiated) is greater than a value. For example, a WTRU may start or re-start a timer at the beginning or end of a COT, and, if the timer expires, the WTRU may be allowed to initiate a COT on a conditional FFP. Regarding priority of a transmission, for example, a WTRU may initiate a COT on an FFP if the priority of the transmission is greater than a threshold. Regarding the outcome of a previous attempt to initiate a COT, for example, the WTRU may only initiate a COT on a conditional FFP if the WTRU failed to initiate a COT (e.g., failed LBT) in one or more previous FFPs. For example, the WTRU may maintain a counter and increment the counter for every failed COT initiation. The WTRU may decrement the counter (e.g., decrement to 0) when it successfully initiates a COT. If the value of the counter goes above a threshold, the WTRU may initiate a COT on a conditional FFP.

As per embodiments described herein, a WTRU may initiate a COT in an FFP even if there is an ongoing COT. Furthermore, the WTRU may be configured with multiple possibly overlapping FFP configurations. Therefore, there may be transmissions for which there may be ambiguity at the gNB as to whether the WTRU initiated a new COT on a new FFP and for which FFP configuration. In cases where there may be ambiguity, the WTRU may indicate whether a new COT has been initiated or the FFP configuration on which the COT has been initiated. Such an indication may use FFP-UCI or CG-UCI.

A WTRU in DRX may enter an onDuration where it may monitor the channel for DL transmissions. An onDuration may be defined as including at least the start of one gNB FFP configuration (e.g., an FFP configuration on which the gNB may initiate a COT). If a WTRU in DRX wishes to transmit in a configured resource, the WTRU may be required to monitor at least one gNB FFP configuration prior to attempting to initiate a COT in a WTRU-specific FFP.

In some cases, a WTRU may be configured with resources for UL transmissions that may occur during COTs initiated by the gNB or another WTRU. In order for the WTRU to use such resources, the gNB may not transmit on them. However, in some cases, the resources may not be used by the WTRU for whom it is configured. A WTRU may be indicated, or configured with, a set of resources or slots in a gNB-initiated COT that may be used by that or another WTRU. If a configured resource is not used by a WTRU, the WTRU may assume that the COT has ended in that FFP. However, if a configured resource assigned to first WTRU is not used, a second WTRU may not be aware that a COT has ended due to an unused gap. Therefore, the WTRU may monitor for the presence of a signal in all of the configured resources, including those assigned to other WTRUs. If the WTRU does not detect a transmission, it may assume the COT has ended. In another method, the WTRU may expect a DL transmission in the first available DL slot after a slot used for configured UL transmission. If the WTRU does not receive a DL transmission in such a slot, it may assume the COT has ended.

A WTRU may receive triggering in a gNB-initiated COT to determine if configured resources occurring within the gNB-initiated COT are valid and may be used for UL transmission. In such a scenario, the WTRU may determine whether a COT is still active after a configured resource based on the methods presented herein.

A WTRU may indicate to the gNB if it will use an upcoming configured resource (e.g., an upcoming configured resource occurring in a current or subsequent COT). This may enable the gNB to know whether to leave a gap for such resources or to use them for scheduled transmissions.

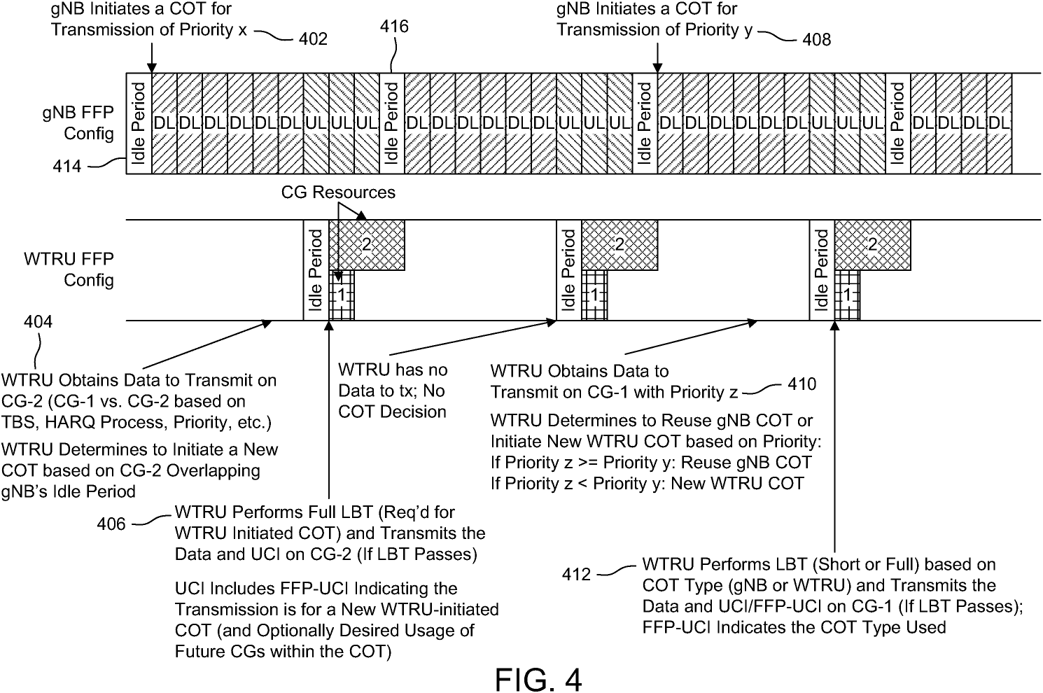

FIG. 4 a diagram illustrating a method to enable a WTRU to initiate (e.g. a WTRU-initiated COT) and/or share a COT (e.g. gNB-initiated COT). As shown in FIG. 4, in one exemplary embodiment, at 402, a gNB, during the gNB FFP idle period 414, may initiate a COT for a transmission with a first priority (“priority x”). At 404, the WTRU may obtain data to transmit on a first configured grant (CG-1) or second configured grant (CG-2). The WTRU may select the configured grant based on required TBS, HARQ process, priority, etc. The UE may determine to initiate a new WTRU-initiated COT if it doesn’t detect that the gNB initiated a COT at 402. The WTRU may determine to initiate a new COT based on CG-2 overlapping the gNB’s idle period 416. At 406, the WTRU may attempt to initiate a new WTRU-initiated COT, the WTRU may perform a full LBT (e.g. CAT4 or Type 1 LBT) and, if the LBT passes, transmit the data and UCI on the CG-2. The UCI may include FFP-UCI that indicates that the transmission is for a new WTRU-initiated COT. In the event that the WTRU has no data to transmit, the WTRU does not determine whether to initiate a new COT. Not shown in the figure is the case where a WTRU detects that a gNB initiated a COT at 402, and the WTRU selects CG-1 at 404 and determines to share the gNB COT. In this case, in step 406, the WTRU may perform short LBT (e.g. CAT1 or CAT2 or Type 2 LBT) and may transmit data and UCI on CG-1. The UCI may include FFP-UCI that indicates that the transmissions is for a shared gNB-initiated COT.

In another embodiment, at 408 the gNB may initiate a COT for a transmission with a second priority (“priority y”). At 410, the WTRU may obtain data that has a third priority (“priority z”) to transmit on CG-1. The WTRU may determine to reuse the gNB-initiated COT (initiated at 408) or initiate a new UE-initiated COT based on the priority of the data and whether it has detected that the gNB initiated a COT at 408. For example, if the WTRU detects that the gNB initiated a COT at 408 and if priority z is higher than priority y, the WTRU may reuse the gNB-initiated COT. However, if the WTRU doesn’t detect that the gNB initiated a COT at 408 or if priority y is higher than priority z, the WTRU may initiate a new WRTU-initiated COT. At 412, the WTRU performs a LBT (e.g. LBT Type 1 or 2 or CAT1, CAT2 or CAT4) based on the COT type (i.e., gNB-initiated or WTRU-initiated) and, if the LBT passes, transmits the data and UCI/FFP-UCI on CG-1. The FFP-UCI may indicate whether the COT used for the transmission on CG-1 is a new WTRU-initiated COT or a shared gNB-initiated COT.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magnetooptical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), the method comprising:
receiving, from a base station (BS), configuration information that includes a WTRU-specific fixed frame period (FFP) and one or more configured grant (CG) resources;
determining to transmit data using a first CG resource of the one or more CG resources, wherein the first CG resource occurs within the WTRU-specific FFP;
determining to use either a BS-initiated channel occupancy time (COT) or a WTRU-initiated COT, wherein the determination is based on at least one of:
detecting whetherthe BS-initiated COT overlaps with a start of the first CG resource;
whether the first CG resource overlaps a BS FFP idle period;
a priority used for listen before talk (LBT) for the BS-initiated COT; or
a priority of the data to be transmitted;
performing a LBT based on the COT the WTRU determined to use; and
on condition that the LBT is successful, transmitting the data and uplink control information (UCI) in the first CG resource.

2. The method of claim 1, wherein the WTRU-initiated COT is used when:
at least part of the first CG resource overlaps an idle period of the BS FFP; or the priority of the data to be transmitted is lower than the priority used by the BS for LBT of the BS-initiated COT.

3. The method of claim 1, wherein the LBT performed is a full LBT or Type 1 LBT.

4. The method of claim 1, wherein the LBT performed is a short LBT or Type 2 LBT.

5. The method of claim 1, wherein the UCI includes a FFP-UCI that indicates the WTRU determined to use the BS-initiated COT or the WTRU-initiated COT.

6. A wireless transmit/receive unit (WTRU) comprising:
a receiver configured to receive, from a base station (BS) configuration information that includes a WTRU-specific fixed frame period (FFP) and one or more configured grant (CG) resources;
a processor configured to:
determine to transmit data using a first CG resource of the one or more CG resources, wherein the first CG resource occurs within the WTRU-specific FFP;
determine to use either a BS-initiated channel occupancy time (COT) or a WTRU-initiated COT, wherein the determination is based on at least one of:
detecting whether the BS-initiated COT overlaps with a start of the first CG resource;
whether the first CG resource overlaps a BS FFP idle period;
a priority used for listen before talk (LBT) for the BS-initiated COT; or
a priority of the data to be transmitted;
perform a LBT based on the COT the WTRU determined to use; and
on a condition that the LBT was successful, a transmitter configured to transmit the data and uplink control information (UCI) in the first CG resource.

7. The WTRU of claim 6, wherein the WTRU-initiated COT is used when:
at least part of the first CG resource overlaps an idle period of the BS FFP; or
the priority of the data to be transmitted is lower than the priority used by the BS for LBT of the BS-initiated COT.

8. The WTRU of claim 6, wherein the LBT performed is a full LBT or Type 1 LBT.

9. The WTRU of claim 6, wherein the LBT performed is a short LBT or Type 2 LBT.

10. The WTRU of claim 6, wherein the UCI includes a FFP-UCI that indicates the WTRU determined to use the BS-initiated COT or the WTRU-initiated COT.

11. The method of claim 1, wherein the UCI indicates whether the WTRU is using the BS-initiated COT or the WTRU-initiated COT.

12. The WTRU of claim 6, wherein the UCI indicates whether the WTRU is using the BS-initiated COT or the WTRU-initiated COT.
